(19) United States
(12) Patent Application Publication
(10) Pub. No.: US 2025/0298179 A1
(43) Pub. Date: Sep. 25, 2025

(54) ANTI-PEEPING BACKLIGHT ASSEMBLY

(71) Applicant: DARWIN PRECISIONS CORPORATION, Hsinchu County (TW)

(72) Inventors: Chun-Fu Chuang, Hsinchu County (TW); Wen-Tai Shen, Hsinchu County (TW)

(21) Appl. No.: 19/023,467

(22) Filed: Jan. 16, 2025

(30) Foreign Application Priority Data
Mar. 22, 2024 (TW) 113110792

(51) Int. Cl. F21V 8/00

(52) U.S. Cl. CPC G02B 6/0076; G02B 6/002; G02B 6/0043; G02B 6/0053; G02B 6/0073; G02B 6/0088; G02B 6/009; G02B 6/0091

(57) ABSTRACT

An anti-peeping backlight assembly includes the following features. The anti-peeping film has a first surface and a second surface opposite to each other. The direct-type backlight module includes a first light-emitting element and an optical plate. The optical plate is opposite to the first surface, and is adapted to guide a light beam of the first light-emitting element to pass through the anti-peeping film. The edge-type backlight module includes a second light-emitting element and a light guide plate. The light guide plate is opposite to the second surface, and has a light incident surface and a light-emitting surface connected. The second light-emitting element is located opposite to the light incident surface. The light-emitting surface faces away from the second surface, and the light-emitting surface is adapted to allow the light beam and a light beam of the second light-emitting element to be emitted.

### CROSS-REFERENCE TO RELATED APPLICATIONS

This application claims the benefit of Taiwanese Application No. 113110792, filed on Mar. 22, 2024, which is hereby incorporated by reference for all purposes as if fully set forth herein.

### FIELD OF THE INVENTION

The present invention relates to a backlight assembly, and more particularly to an anti-peeping backlight assembly.

### BACKGROUND OF THE INVENTION

Electronic products in daily life such as a television, a desktop computer, a laptop, a tablet, and a smartphone are configured with a display device. Furthermore, a size and a shape of the display device can be changed according to different purposes, and some display devices can be configured with a curved screen to provide different visual effect.

As the display devices are widely used in various occasions, an anti-peeping function of the display device is becoming more and more important. Most of the conventional display devices have a light shielding sheet attached to the screen to limit an angle of the light emitted from the screen, thereby achieving the anti-peeping effect. However, the brightness of the screen is largely reduced by the light shield sheet, which results in poor image quality.

### SUMMARY OF THE INVENTION

The present invention provides an anti-peeping backlight assembly to improve the light-emitting brightness and contrast.

To achieve one, part or all of the above purposes or other purposes, an anti-peeping backlight assembly provided by the present invention includes an anti-peeping sheet, a direct-type backlight module and an edge-type backlight module. The anti-peeping sheet has a first surface and a second surface opposite to the first surface. The direct-type backlight module includes a first light-emitting element and an optical plate. The first light-emitting element is adapted to generate a first light beam. The optical plate is disposed opposite to the first surface, and the optical plate is adapted to guide the first light beam to pass through the anti-peeping sheet. The edge-type backlight module includes a second light-emitting element and a light guide plate. The light guide plate is disposed opposite to the second surface, and the light guide plate has a light incident surface and a light-emitting surface connected to the light incident surface. The second light-emitting element is disposed opposite to the light incident surface, and is adapted to generate a second light beam. The light-emitting surface faces away from the second surface, and the light-emitting surface is adapted to allow the first light beam and the second light beam to be emitted.

In an embodiment of the present invention, the optical plate has, for example, a reflective cup structure. The reflective cup structure has a reflective wall and a light-emitting opening connected to the reflective wall. The light-emitting opening faces the anti-peeping sheet, and the first light-emitting element is disposed in the reflective cup structure and is surrounded by the reflective wall.

In an embodiment of the present invention, the optical plate may have a third surface and a fourth surface. The third surface is opposite to the fourth surface, and the third surface faces away from the anti-peeping sheet and is opposite to the first light-emitting element. The third surface and/or the fourth surface have a plurality of light-diffusing microstructures.

In an embodiment of the present invention, the first light-emitting element has a top surface and a side surface, and the top surface is connected to the side surface and faces the optical plate. At least one of the top surface and the side surface may be adapted to allow the first light beam to be emitted.

In an embodiment of the present invention, the direct-type backlight module further includes, for example, a shading portion, and the shading portion covers the top surface or the side surface.

In an embodiment of the present invention, the anti-peeping backlight assembly may further include a wavelength-converting film, and the wavelength-converting film is disposed between the optical plate and the anti-peeping sheet.

In an embodiment of the present invention, the anti-peeping sheet includes, for example, a grating sheet.

In an embodiment of the present invention, the light guide plate further has a surface. The surface faces away from the light-emitting surface, and may have a plurality of light-scattering microstructures.

In an embodiment of the present invention, a depth of each of the light-scattering microstructures sunken in the surface is D, and a width of each of the light-scattering microstructures is W, wherein 1≤W/D≤40.

In an embodiment of the present invention, W and D are ranged such as 15 μm≤W≤40 μm and 1 μm≤D≤15 μm.

The anti-peeping backlight assembly of the present invention uses the anti-peeping sheet, the direct-type backlight module, and the edge-type backlight module, wherein the anti-peeping sheet is disposed between the direct-type backlight module and the edge-type backlight module to reduce an emitted angle of the first light beam. In addition, the second light beam is emitted from the light guide plate without passing through the anti-peeping sheet, so an angle of the second light beam emitted from the light guide plate is greater than that of the first light beam. Therefore, the anti-peeping backlight assembly has a greater viewing angle when the edge-type backlight module is turned on, and has a smaller viewing angle when the edge-type backlight module is turned off, thereby providing an anti-peeping function. Additionally, because the direct-type backlight module has an advantage of high light-emitting brightness, and further can provide a local dimming function, the anti-peeping backlight assembly of the present invention can effectively improve the light-emitting brightness and the contrast.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of an anti-peeping backlight assembly in an embodiment of the present invention;

FIG. 2 is a three dimensional schematic diagram of the light-diffusing microstructures of a direct-type backlight module in another embodiment of the present invention;

FIG. 3 is a cross-sectional schematic diagram of the two adjacent light-diffusing microstructures in FIG. 2;

FIG. 4 is a three dimensional schematic diagram of a first light-emitting element of the direct-type backlight module in another embodiment of the present invention;

FIG. 5 is a schematic diagram of the light field of the light emitted from an anti-peeping backlight assembly in another embodiment of the present invention;

FIG. 6 is a schematic diagram of the relation between the light-emitting brightness and the horizontal viewing angle of the anti-peeping backlight assembly in another embodiment of the present invention;

FIG. 7 is a schematic diagram of an anti-peeping backlight assembly in another embodiment of the present invention;

FIG. 8 is a schematic diagram of a direct-type backlight module in another embodiment of the present invention;

FIG. 9 is a schematic diagram of a direct-type backlight module in another embodiment of the present invention;

FIG. 10 is a schematic diagram of an anti-peeping backlight assembly in another embodiment of the present invention;

FIG. 11 is an enlarged schematic diagram of the light-scattering microstructures in FIG. 10; and

FIG. 12 is a schematic diagram of an anti-peeping backlight assembly in another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

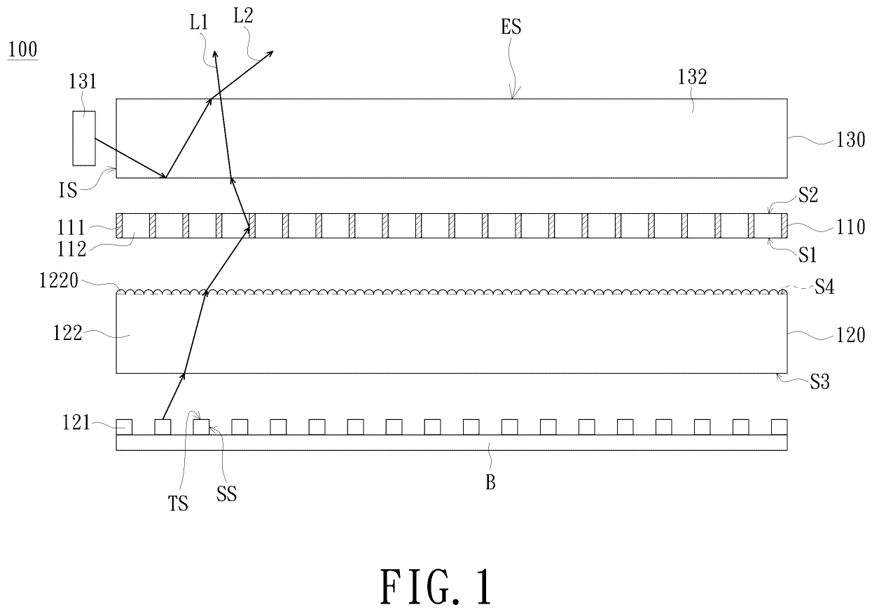

FIG. 1 is a schematic diagram of an anti-peeping backlight assembly in an embodiment of the present invention. Referring to FIG. 1, an anti-peeping backlight assembly 100 includes an anti-peeping sheet 110, a direct-type backlight module 120, and an edge-type backlight module 130. The anti-peeping sheet 110 has a first surface S1 and a second surface S2 opposite to the first surface S1. The direct-type backlight module 120 includes a first light-emitting element 121 and an optical plate 122. The first light-emitting element 121 is adapted to generate a first light beam L1. The optical plate 122 is disposed opposite to the first surface S1 and adapted to guide the first light beam L1 to pass through the anti-peeping sheet 110. The edge-type backlight module 130 includes a second light-emitting element 131 and a light guide plate 132. The light guide plate 132 is disposed opposite to the second surface S2 and has a light incident surface IS and a light-emitting surface ES connected to the light incident surface IS. The second light-emitting element 131 is disposed opposite to the light incident surface IS and is adapted to generate a second light beam L2. The light-emitting surface ES faces away from the second surface S2 and is adapted to allow the first light beam L1 and the second light beam L2 to be emitted.

It should be noted that the anti-peeping sheet 110 is able to reduce the emitted angle of the first light beam L1. In addition, because the second light beam L2 is emitted from the light-emitting surface ES without passing through the anti-peeping sheet 110, the angle of the first light beam L1 emitted from the light-emitting surface ES is smaller than that of the second light beam L2. Furthermore, when the anti-peeping backlight assembly 100 is operation, the first light-emitting element 121 is continuously activated so the direct-type backlight module 120 can continuously provide the first light beam L1. In this way, the second light beam L2 provided by the edge-type backlight module 130 is emitted from the light-emitting surface ES together with the first light beam L2 when the second light-emitting element 131 is activated, so that the anti-peeping backlight assembly 100 can provide a greater viewing angle; in this case, the anti-peeping backlight assembly 100 is in share mode. Alternatively, there is no second light beam L2 to gain the viewing angle of the anti-peeping backlight assembly 100 when the second light-emitting element 131 is turned off, so that the anti-peeping backlight assembly 100 can provide a smaller viewing angle; in this case, the anti-peeping backlight assembly 100 is in a privacy mode. Incidentally, the anti-peeping backlight assembly 100 may be configured with a display panel to form a display device in an embodiment, wherein the display panel may be disposed opposite to the light-emitting surface ES. The display panel may include a liquid crystal display panel in another embodiment, but which is not limited by the present invention.

In this embodiment, the direct-type backlight module 120 is able to provide the first light beam L1 in the share mode and the privacy mode. Particularly, because the direct-type backlight module 120 has the function of local diming, the anti-peeping backlight assembly 100 can effectively improve the contrast both in the share mode and the privacy mode. For example, compared with the anti-peeping backlight assembly in the conventional art using two sets of the edge-type backlight modules, the anti-peeping backlight assembly 100 using the direct-type backlight module 120 and the edge-type backlight module 130 can double the contrast in an embodiment. Additionally, compared with the conventional edge-type backlight module, the direct-type backlight module 120 in this embodiment can be configured with more light-emitting elements (i.e., the first light-emitting element 121). In addition, because the gap between each two adjacent light-emitting elements (i.e., the first light-emitting elements 121) in the direct-type backlight module 120 is greater than that in the conventional edge-type backlight module, the direct-type backlight module 120 can further improve the heat dissipation efficiency, thereby improving the luminous power of each first light-emitting element 121. Based on the above, the direct-type backlight module 120 can further effectively improve the light-emitting brightness of the anti-peeping backlight assembly 100 in the share mode and the privacy mode. Additionally, because the gap between each two adjacent first light-emitting elements 121 can be widened, the quantity of the first light-emitting elements 121 can further be reduced in an embodiment, thereby reducing the electric power consumption. For example, the direct-type backlight module 120 in another embodiment can reduce the electric power consumption by about 40%, compared with the conventional edge-type backlight module. Additionally, the conventional edge-type backlight module is configured with a light guide plate, and the light guide plate is easy to leave scratches during the assemble process. Therefore, the anti-peeping backlight assembly 100 using the direct-type backlight module 120 can further improve the yield of assembly.

The optical plate 122 in this embodiment is located on the transmission path of the first light beam L1 to guide the first light beam L1 to be incident on the anti-peeping sheet 110. Particularly, the optical plate 122 can have a third surface S3 and a fourth surface S3. The third surface S3 is opposite to the fourth surface S4, the third surface S3 faces away from the anti-peeping sheet 110, and the third surface S3 is opposite to the first light-emitting element 121. The third surface S3 and/or the fourth surface S4 have a plurality of light-diffusing microstructures 1220, and this embodiment takes the fourth surface S4 having the light-diffusing microstructures 1220 as an example. In this way, the optical plate 122 can provide the function of diffusing light, thereby improving the uniformity of the light emitted from the direct-type backlight module 120. The light-diffusing microstructures 1220 are protruded from the fourth surface S4 in this embodiment, but the light-diffusing microstructures 1220 may be recessed in the fourth surface S4 in an embodiment. Additionally, the light-diffusing microstructures 1220 may be in shapes of dot like in this embodiment, but other embodiments are not limited thereto.

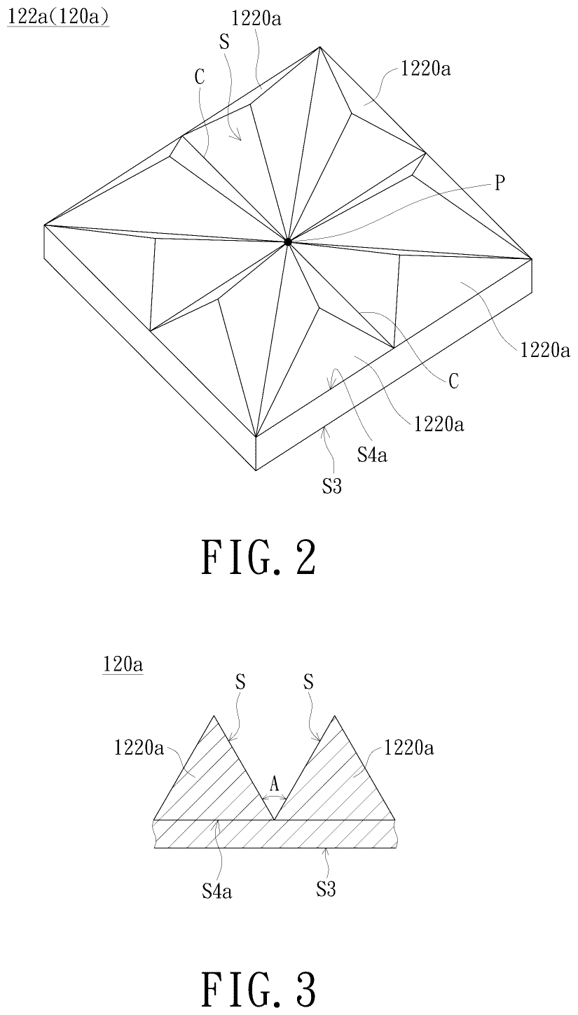

FIG. 2 is a three dimensional schematic diagram of the light-diffusing microstructures of a direct-type backlight module in another embodiment of the present invention. FIG. 3 is a cross-sectional schematic diagram of the two adjacent light-diffusing microstructures in FIG. 2. For example, referring to the direct-type backlight module 120a in FIGS. 2 and 3, each of the light-diffusing microstructures 1220a of the optical plate 122a may have an inclined surface S. The inclined surfaces S stand on the third surface S3 and/or the fourth surface S4a, and the inclined surfaces S stand, for example, on the fourth surface S4a in this embodiment. The inclined surfaces S are inclined with respect to the third surface S3 and the fourth surface S4a. The two adjacent inclined surfaces S of the two adjacent light-diffusing microstructures 1220a face each other, and the two the inclined surfaces S are adjacent to a connecting line C (drawn in FIG. 2). An angle A (labeled in FIG. 3) is included between the two inclined surfaces S. The angle A is, for example, between 30 degrees and 150 degrees. The two connecting lines C of the four adjacent light-diffusing microstructures 1220a of all the light-diffusing microstructures 1220a intersect at an intersection point P, and the eight adjacent light-diffusing microstructures 1220a of all the light-diffusing microstructures 1220a are around the intersection point P and adjacent to each other. In this way, the uniformity of the light emitted from the optical plate 122a can be further improved, thereby improving the optical grade of the direct-type backlight module 120a. Additionally, because the optical plate 122a is able to make the light emitted more uniformly, the distance between the optical plate 122a and the first light-emitting element 121 (drawn in FIG. 1) can be further reduced, thereby reducing the thickness of the direct-type backlight module 120a. On the other hand, because the optical plate 122a is able to make the light emitted more uniformly, the gap between the first light-emitting elements 121 can further be increased, thereby reducing the quantity of the first light-emitting elements 121, and thus the cost of the direct-type backlight module 120a can be further reduced.

Referring to FIG. 1 again, the first light-emitting element 121 in this embodiment includes, for example, a light-emitting diode, but the present invention is not limited thereto. The first light-emitting element 121 has a top surface TS and a side surface SS in this embodiment, and the top surface TS is connected to the side surface SS and faces the optical plate 122. At least one of the top surface TS and the side surface SS can allow the first light beam L1 to be emitted. For example, the first light-emitting element 121 in this embodiment can provide the first light beam L1 via the top surface TS and the side surface SS. Furthermore, the first light-emitting element 121 may be fixed to the substrate B via chip scale package (CSP), but which is not limited by the present invention.

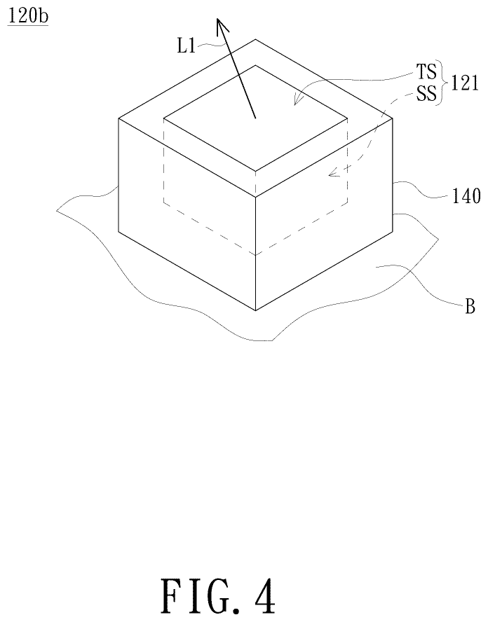

FIG. 4 is a three dimensional schematic diagram of a first light-emitting element of the direct-type backlight module in another embodiment of the present invention. In an embodiment such as shown in FIG. 4, the top surface TS of the first light-emitting element 121 may be adapted to allow the first light beam L1 to be emitted. Particularly, the direct-type backlight module 120b further includes, for example, a shading portion 140, and the shading portion 140 may cover the side surface SS so the first light beam L1 is allowed to be emitted from the top surface TS. For example, the first light-emitting element 121 in this embodiment includes four side surfaces SS, and the shading portion 140 may cover the four side surfaces SS. It should be noted that the direct-type backlight module 120 in FIG. 1 in an embodiment may use the shading portion 140 in FIG. 4 so the first light beam L1 is emitted from the top surface TS of the first light-emitting element 121. Similarly, the optical plate 122a in FIG. 2 may also be configured with the first light-emitting element 121 provided with the shading portion 140 so the first light beam L1 is emitted from the top surface TS of the first light-emitting element 121. Incidentally, the first light-emitting element 121 and the shading portion 140 may be fixed to the substrate B via chips on board (COB) or package on board (POB) in the embodiment in FIG. 4, but which is not limited by the present invention.

Referring to FIG. 1 again, the anti-peeping sheet 110 in this embodiment is disposed on the transmission path of the first light beam L1 after being emitted from the fourth surface S4, so that the first light beam L1 may be incident to the edge-type backlight module 130 at a smaller angle. Specifically, the anti-peeping sheet 110 includes, for example, a grating sheet. Furthermore, the anti-peeping sheet 110 may include a plurality of shading parts 111 and a plurality of light-transmitting parts 112. The shading parts 111 are spaced apart from each other, and the light-transmitting parts 112 are disposed between two adjacent shading parts 111. The shading parts 111 can block the first light beam L1, and the light-transmitting parts 112 can allow the first light beam L1 to pass through and reduce the angle of the first light beam L1 emitted from the light-transmitting parts 112.

The light guide plate 132 of the edge-type backlight module 130 is located on the transmission path of the first light beam L1 after being emitted from the anti-peeping sheet 110 to allow the first light beam L1 to pass through and then to be emitted from the light-emitting surface ES. Additionally, the light incident surface IS of the light guide plate 132 can allow the second light beam L2 to be incident thereon, and the light guide plate 132 can guide the second light beam L2 to be emitted from the light-emitting surface ES. The second light-emitting element 131 includes, for example, a light-emitting diode in this embodiment, but the invention is not limited thereto.

Compared with the conventional art, the anti-peeping backlight assembly 100 in this embodiment uses the anti-peeping sheet 110, the direct-type backlight module 120, and the edge-type backlight module 130, wherein the anti-peeping sheet 110 is disposed between the direct-type backlight module 120 and the edge-type backlight module 130 to reduce the emitted angle of the first light beam L1. Additionally, the second light beam L2 is emitted from the light guide plate 132 without passing through the anti-peeping sheet 110 so the angle of the second light beam L2 emitted from the light guide plate 132 is greater than that of the first light beam L1. Therefore, the anti-peeping backlight assembly 100 has a greater visible angle when the edge-type backlight module 130 is turned on, and the anti-peeping backlight assembly 100 has a smaller visible angle when the edge-type backlight module 130 is turned off, thereby providing an anti-peeping function. Additionally, because the direct-type backlight module 120 has the advantage of high light-emitting brightness and further can provide the local dimming function, the anti-peeping backlight assembly 100 in this embodiment can effectively improve the light-emitting brightness and the contrast.

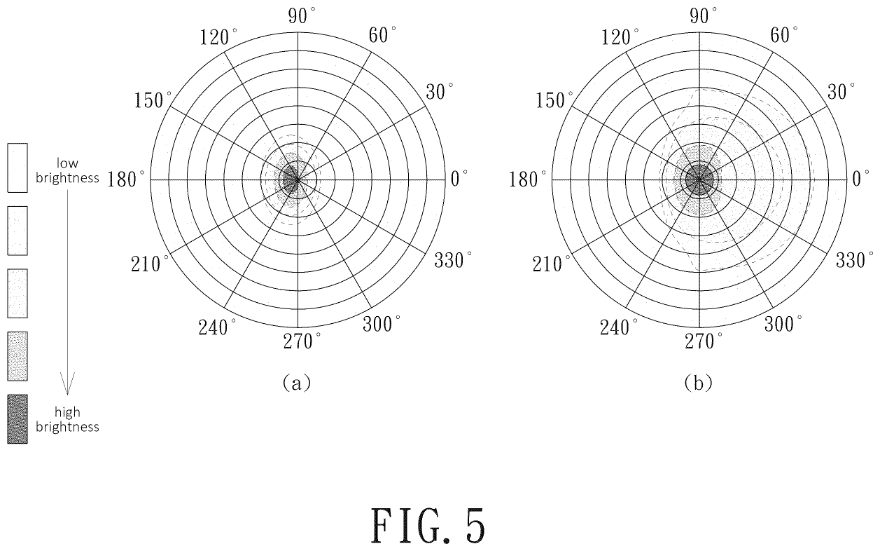

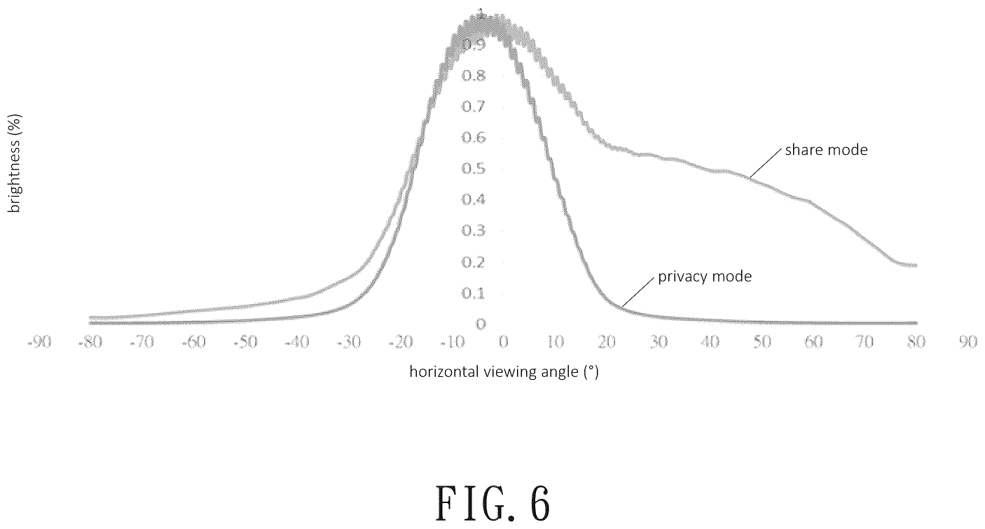

FIG. 5 is a schematic diagram of the light field of the light emitted from an anti-peeping backlight assembly in another embodiment of the present invention. FIG. 6 is a schematic diagram of the relation between the light-emitting brightness and the horizontal viewing angle of the anti-peeping backlight assembly in another embodiment of the present invention. For example, referring to FIGS. 5 and 6, the anti-peeping backlight assembly 100 in this embodiment can be applied to a vehicle-mounted display device for a driver's seat. In the privacy mode, the angle of the light emitted from the anti-peeping backlight assembly 100 is smaller to display an image toward the driver's seat. On the other hand, in the share mode, the angle of the light emitted from the anti-peeping backlight assembly 100 is greater, and the direction of the emitted light is more shifted to the right compared to the privacy mode, so that the image can be displayed toward the driver's seat and the passenger seat at the same time. However, the anti-peeping backlight assembly 100 in other embodiments can be applied to a desktop computer, and the specific use of the anti-peeping backlight assembly 100 is not limited by the present invention.

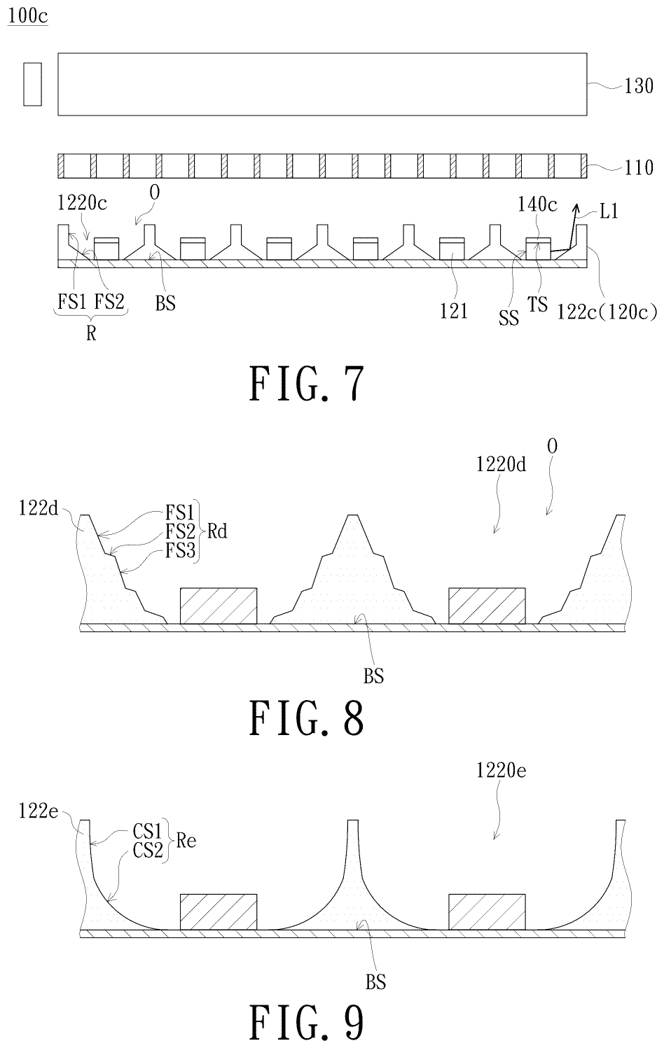

FIG. 7 is a schematic diagram of an anti-peeping backlight assembly in another embodiment of the present invention. FIG. 8 is a schematic diagram of a direct-type backlight module in another embodiment of the present invention. FIG. 9 is a schematic diagram of a direct-type backlight module in another embodiment of the present invention. The structure and advantages of the anti-peeping backlight assembly 100c in this embodiment are similar to those of the embodiment in FIG. 1, and only the differences are described below. Referring to FIG. 7 first, the optical plate 122c of the direct-type backlight module 120c has, for example, a reflective cup structure 1220c. The reflective cup structure 1220c has a reflective wall R and a light-emitting opening O connected to the reflective wall R. The light-emitting opening O faces the anti-peeping sheet 110, and the first light-emitting element 121 is disposed in the reflective cup structure 1220c and is surrounded by the reflective wall R. Specifically, the reflective cup structure 1220c may further have a bottom surface BS opposite to the light-emitting opening O, the reflective wall R may have a plurality of flat surfaces, and there are two flat surfaces FS1 and FS2 as an example in this embodiment. The flat surfaces FS1 and FS2 each are inclined with respect to the bottom surface BS, and the slope of the flat surface FS1 with respect to the bottom surface BS is greater than the slope of the flat surface FS2 with respect to the bottom surface BS. Briefly, the slope of the flat surface (such as the flat surfaces FS1) closer to the light-emitting opening O is greater; on the contrary, the slope of the flat surface (such as the flat surfaces FS2) further away from the light-emitting opening O is smaller. For example, the flat surfaces FS1 in an embodiment may be substantially vertical to the bottom surface BS, and the flat surface FS2 may be substantially parallel to the bottom surface BS. In another embodiment such as the optical plate 122d shown in FIG. 8, the reflective wall Rd of the reflective cup structure 1220d may include flat surfaces FS1, FS2, and FS3, and the slopes of the flat surfaces FS1, FS2, and FS3 with respect to the bottom surface BS may be in a staggered manner with steep slopes and gentle slopes from the light-emitting opening O toward the bottom surface BS, so that the shape of the reflective wall Rd is similar to a staircase. In another embodiment such as the optical plate 122e shown in FIG. 9, the reflective wall Re of the reflective cup structure 1220e may include a plurality of curved surfaces, and there are two curved surfaces CS1 and CS2 as an example in FIG. 9. The curvature of the curved surface CS1 may be less than the curvature of the curved surface CS2. Similarly, the curved surface CS1 may be substantially vertical to the bottom surface BS in one embodiment, while the curved surface CS2 may be substantially parallel to the bottom surface BS in another embodiment.

Referring to FIG. 7 again, the side surface SS of the first light-emitting element 121 in this embodiment may be adapted to allow the first light beam L1 to be emitted. Furthermore, the shading portion 140c may cover the top surface TS so the first light beam L1 is emitted from the side surface SS. The shading portion 140c includes, for example, a distributed Bragg reflector (DBR) in one embodiment, but the present invention is not limited thereto. It can be understood that the first light-emitting element 121 provided with the shading portion 140c may be configured with the optical plate 122d in FIG. 8 or the optical plate 122e in FIG. 9 in other embodiments, which is not limited by the present invention.

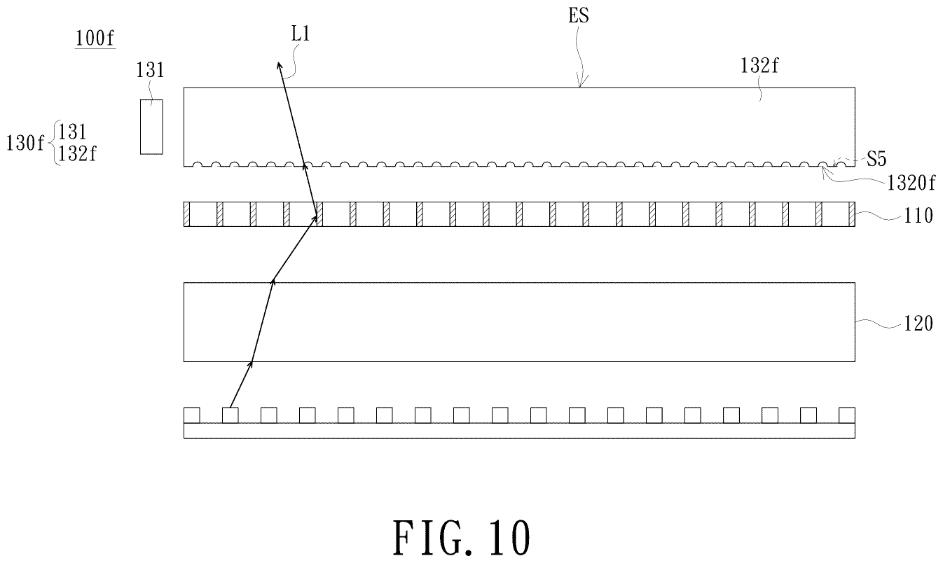

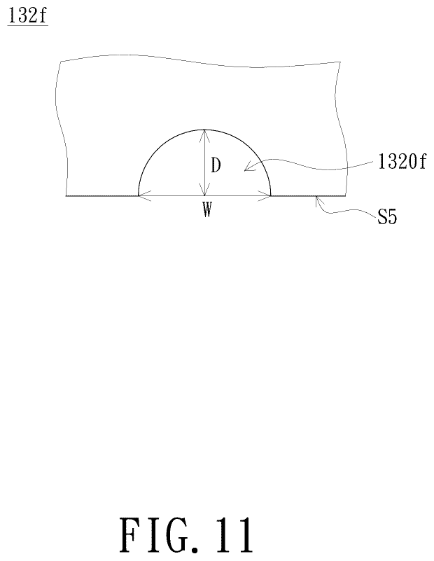

FIG. 10 is a schematic diagram of an anti-peeping backlight assembly in another embodiment of the present invention. FIG. 11 is an enlarged schematic diagram of the light-scattering microstructures in FIG. 10. The structure and advantages of the anti-peeping backlight assembly 100f in this embodiment are similar to those of the embodiment in FIG. 1, and only the differences are described below. Referring to FIGS. 10 and 11, the light guide plate 132f of the edge-type backlight module 130f can further have a surface S5. The surface S5 faces away from the light-emitting surface ES, and the surface S5 can have a plurality of light-scattering microstructures 1320f to improve the uniformity of the light emitted from the light guide plate 132f. Particularly, the depth of each of the light-scattering microstructures 1320f sunken in the surface S5 is D (labeled in FIG. 11), and the width of each the light-scattering microstructures 1320f is W (labeled in FIG. 11), wherein 1≤W/D≤40. In this way, the affecting on the first light beam L1 caused by the light-scattering microstructures 1320f can be reduced so the first light beam L1 can be emitted from the light-emitting surface ES at a smaller angle. In this embodiment, the light-scattering microstructures 1320f may be in shapes of dot like, and the width W is, for example, the dot diameter of the light-scattering microstructures 1320f, but the shape of the light-scattering microstructures 1320f is not limited by the present invention. In an embodiment, W and D may be ranged such as 15 μm≤W≤40 μm and 1 μm≤D≤15 μm to further reduce the affecting on the first light beam L1 caused by the light-scattering microstructures 1320f. In another embodiment, W may be ranged such as 15 μm≤W≤25 μm to further reduce the affecting on the first light beam L1 caused by the light-scattering microstructures 1320f. Incidentally, the light-scattering microstructures 1320f may be protruded from the surface S5 in other embodiments. In another embodiment, the light-scattering microstructures 1320f may include, for example, printed dots, and the dot diameter of the light-scattering microstructures 1320f may be between 100 μm and 150 μm to reduce the affecting on the first light beam L1 caused by the light-scattering microstructures 1320f.

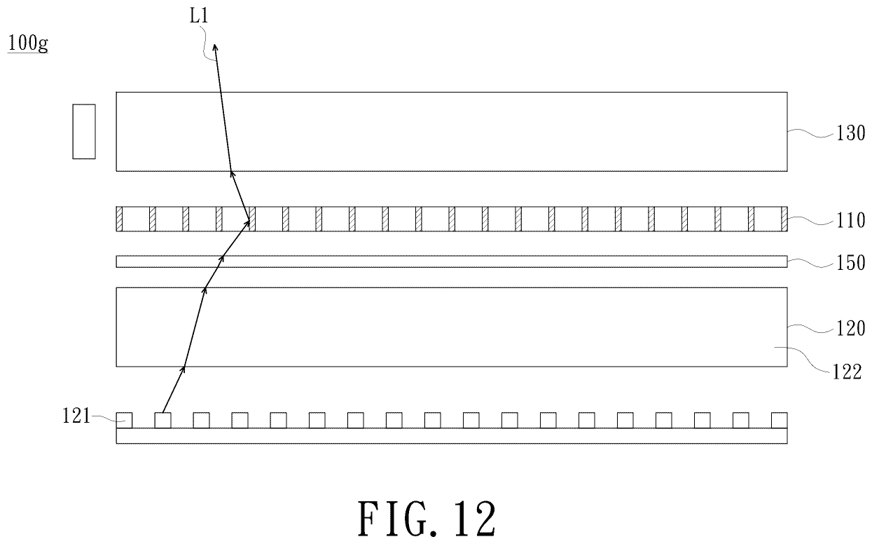

FIG. 12 is a schematic diagram of an anti-peeping backlight assembly in another embodiment of the present invention. The structure and advantages of the anti-peeping backlight assembly 100g in this embodiment are similar to those of the embodiment in FIG. 1, and only the differences are described below. Referring to FIG. 12, the anti-peeping backlight assembly 100g can further include a wavelength-converting film 150, and the wavelength-converting film 150 is disposed between the optical plate 122 and the anti-peeping sheet 110. Furthermore, the color of the first light beam L1 is, for example, the color other than white, and the wavelength-converting film 150 can convert the color of the first light beam L1 to white. For example, the first light-emitting element 121 is able to generate a blue first light beam L1 in this embodiment, and the wavelength-converting film 150 can convert the blue first light beam L1 to a white light beam. However, the first light-emitting element 121 is able to generate a white first light beam L1 in an embodiment so the wavelength-converting film 150 may be omitted in the anti-peeping backlight assembly 100g.

In summary, the anti-peeping backlight assembly of the present invention uses the anti-peeping sheet, the direct-type backlight module, and the edge-type backlight module, wherein the anti-peeping sheet is disposed between the direct-type backlight module and the edge-type backlight module to reduce an emitted angle of the first light beam. In addition, the second light beam is emitted from the light guide plate without passing through the anti-peeping sheet, so an angle of the second light beam emitted from the light guide plate is greater than that of the first light beam. Therefore, the anti-peeping backlight assembly has a greater viewing angle when the edge-type backlight module is turned on, and has a smaller viewing angle when the edge-type backlight module is turned off, thereby providing an anti-peeping function. Additionally, because the direct-type backlight module has an advantage of high light-emitting brightness, and further can provide a local dimming function, the anti-peeping backlight assembly of the present invention can effectively improve the light-emitting brightness and the contrast.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An anti-peeping backlight assembly, comprising:
an anti-peeping sheet, having a first surface and a second surface opposite to the first surface;
a direct-type backlight module, comprising a first light-emitting element and an optical plate, wherein the first light-emitting element is adapted to generate a first light beam, and the optical plate is disposed opposite to the first surface and adapted to guide the first light beam to pass through the anti-peeping sheet; and
an edge-type backlight module, comprising a second light-emitting element and a light guide plate, wherein the light guide plate is disposed opposite to the second surface and has a light incident surface and a light-emitting surface connected to the light incident surface, the second light-emitting element is disposed opposite to the light incident surface and adapted to generate a second light beam, and the light-emitting surface faces away from the second surface and is adapted to allow the first light beam and the second light beam to be emitted.

2. The anti-peeping backlight assembly according to claim 1, wherein the optical plate has a reflective cup structure, the reflective cup structure has a reflective wall and a light-emitting opening connected to the reflective wall, the light-emitting opening faces the anti-peeping sheet, and the first light-emitting element is disposed in the reflective cup structure and surrounded by the reflective wall.

3. The anti-peeping backlight assembly according to claim 1, wherein the optical plate has a third surface and a fourth surface, the third surface is opposite to the fourth surface, the third surface faces away from the anti-peeping sheet and is opposite to the first light-emitting element, and the third surface and/or the fourth surface have a plurality of light-diffusing microstructures.

4. The anti-peeping backlight assembly according to claim 1, wherein the first light-emitting element has a top surface and a side surface, the top surface is connected to the side surface and faces the optical plate, and at least one of the top surface and the side surface is adapted to allow the first light beam to be emitted.

5. The anti-peeping backlight assembly according to claim 4, wherein the direct-type backlight module further comprises a shading portion, and the shading portion covers the top surface or the side surface.

6. The anti-peeping backlight assembly according to claim 1, further comprising a wavelength-converting film, wherein the wavelength-converting film is disposed between the optical plate and the anti-peeping sheet.

7. The anti-peeping backlight assembly according to claim 1, wherein the anti-peeping sheet comprises a grating sheet.

8. The anti-peeping backlight assembly according to claim 1, wherein the light guide plate further comprises a surface, and the surface facing away from the light-emitting surface and has a plurality of light-scattering microstructures.

9. The anti-peeping backlight assembly according to claim 8, wherein a depth of each of the light-scattering microstructures sunken in the surface is D, and a width of each of the light-scattering microstructures is W, wherein 1≤W/D≤40.

10. The anti-peeping backlight assembly according to claim 8, wherein a depth of each of the light-scattering microstructures sunken in the surface is D, and a width of each of the light-scattering microstructures is W, wherein 15 μm≤W≤40 μm, and 1 μm≤D≤15 μm.
